(19) United States
(12) Patent Application Publication
(10) Pub. No.: US 2026/0050394 A1
(43) Pub. Date: Feb. 19, 2026

(54) MEMORY CONTROLLERS AND OPERATION METHODS THEREOF, MEMORY SYSTEMS AND ELECTRONIC SYSTEMS

(71) Applicant: Yangtze Memory Technologies Co., Ltd., Wuhan (CN)

(72) Inventor: Weilin Liu, Wuhan (CN)

(21) Appl. No.: 19/062,961

(22) Filed: Feb. 25, 2025

(30) Foreign Application Priority Data
Aug. 16, 2024 (CN) 202411132376.8

(51) Int. Cl. G06F 3/06

(52) U.S. Cl. CPC G06F 3/0655; G06F 3/0604; G06F 3/0679

(57) ABSTRACT

The present application discloses a memory controller and operation method thereof, memory system and electronic system. The memory controller includes: a storage device, which is configured to store a firmware algorithm; an algorithm execution hardware, which includes a compute expression, and the compute expression is obtained according to a configuration of the firmware algorithm; and a processor, which is connected to the storage device and the algorithm execution hardware, and the processor is configured to call the algorithm execution hardware to perform the compute expression when executing the firmware algorithm, to obtain a compute result of the firmware algorithm.

### CROSS-REFERENCE TO RELATED APPLICATIONS

This application claims priority to and the benefit of Chinese Patent Application 202411132376.8, filed on Aug. 16, 2024, which is hereby incorporated by reference in its entirety.

### TECHNICAL FIELD

The examples of the present application relate to the field of storage technology, for example, memory controllers and methods of operating thereof, memory systems, and electronic systems.

### BACKGROUND

With the development of storage technology, memory systems are increasingly used. A memory system includes a memory controller, which may obtain results of algorithm operation by executing algorithms.

### BRIEF DESCRIPTION OF THE DRAWINGS

In order to more clearly illustrate the technical solutions in the examples of the present application, the drawings required for use in the description of the examples will be briefly introduced below. Obviously, the drawings described below are only some examples of the present application. For the skilled in the art, other drawings can be obtained based on these drawings without creative effort.

FIG. 1 is a schematic diagram of the structure of an electronic system provided in an example of the present application.

FIG. 2 is a schematic diagram of the structure of a memory card provided in an example of the present application.

FIG. 3 is a schematic diagram of the structure of a solid state drive provided in an example of the present application.

FIG. 4 is a schematic diagram of the structure of a memory device provided in an example of the present application.

FIG. 5 is a schematic diagram of the structure of another electronic system provided in an example of the present application.

FIG. 6 is a schematic diagram of the structure of a memory controller provided in an example of the present application.

FIG. 7 is a schematic diagram of a binding relationship between execution hardware and a group of configurable compute expressions provided in an example of the present application.

FIG. 8 is a schematic diagram of a composition structure of any compute expression provided in an example of the present application.

FIG. 9 is a schematic diagram of a compute expression provided in an example of the present application.

FIG. 10 is a schematic diagram of a first compute object in a compute expression provided in an example of the present application.

FIG. 11 is a flowchart of a method of operating a memory controller provided in an example of the present application.

FIG. 12 is a schematic diagram of the structure of a memory system provided in an example of the present application.

FIG. 13 is a schematic diagram of the structure of another electronic system provided in an example of the present application.

### DETAILED DESCRIPTION

In order to make the purpose, technical solutions and advantages of the present application clearer, the examples of the present application will be further described in detail below in conjunction with the accompanying drawings. Although examples of the present application are shown in the accompanying drawings, it should be understood that the present application can be implemented in various forms and should not be limited by the examples described herein. On the contrary, these examples are provided in order to enable a more thorough understanding of the present application and to fully convey the scope of the present application to those skilled in the art. The accompanying drawings are all in a very simplified form and use non-precise proportions, which are only used to conveniently and clearly assist in explaining the purpose of the examples of the present application.

It should be noted that the terms “first”, “second”, etc. in this application are used to distinguish similar objects, and are not necessarily used to describe a specific order or sequence. It should be understood that the data used in this way can be interchangeable in appropriate circumstances, so that the examples of the present application described here can be implemented in an order other than those illustrated or described here. The examples described in the following examples do not represent all examples consistent with the present application. On the contrary, they are only examples consistent with some aspects of the present application.

It should be easily understood that the meaning of “on,” “over,” and “on . . . ” in this application should be interpreted in the broadest manner, so that “on . . . ” not only means “directly on something,” but also includes the meaning of “on something” with intervening features or layers therebetween, and “over . . . ” or “on . . . ” not only means “over something” or “on something,” but also includes the meaning of “over something” or “on something” with no intervening features or layers therebetween (i.e., directly on something).

In addition, spatially relative terms such as “below,” “beneath,” “lower,” “above,” “upper,” etc., may be used herein for ease of description to describe the relationship of one element or feature to (one or more) another element or feature as shown in the figures. The spatially relative terms are intended to encompass different orientations of the device in use or operation in addition to the orientation depicted in the figures. The device may be otherwise oriented (rotated 90 degrees or at other orientations), and the spatially relative descriptors used herein may be interpreted accordingly.

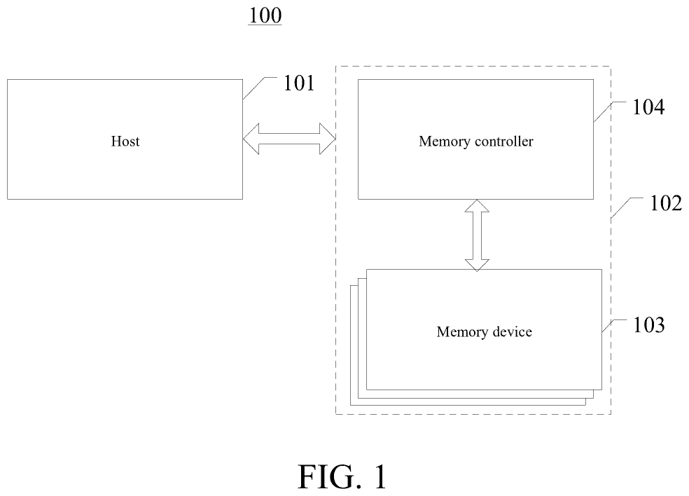

FIG. 1 shows a schematic diagram of an electronic system provided by an example of the present application. The electronic system 100 can be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a storage. Currently, the flexibility of memory controllers in executing algorithms could be improved.

As shown in FIG. 1, the electronic system 100 includes a host 101 and a memory system 102 coupled to the host 101. The host 101 may be a processor (e.g., a central processing unit (CPU)) or a system on chip (SoC) (e.g., an application processor (AP)) of an electronic device. The host 101 may be configured to send data to the memory system 102. Alternatively, the host 101 may be configured to receive data from the memory system 102.

The memory system 102 includes one or more memory device 103 and a memory controller 104. The memory controller 104 is coupled to the memory device 103, and the memory controller 104 is configured to control the memory device 103. The memory device 103 can be any type of memory device. Optionally, the memory device 103 is a NAND (Not AND) flash memory device, such as a 3D NAND flash memory device; or, the memory device 103 is a DRAM (Dynamic Random Access Memory) or the like.

In some examples, the memory controller 104 is also coupled to the host 101. The memory controller 104 may manage data stored in the memory device 103 and communicate with the host 101.

In an implementation, the memory controller 104 is designed to operate in a low duty cycle environment, such as a Secure Digital (SD) card, a Compact Flash (CF) card, a Universal Serial Bus (USB) flash drive, or other media for use in electronic devices such as personal computers, digital cameras, mobile phones, etc.

In an implementation, the memory controller 104 is designed to operate in a high duty cycle environment, such as a solid state disk (SSD) or an embedded multi media card (eMMC). SSD or eMMC is used as data storage for mobile devices such as smart phones, tablet computers, laptops, etc., as well as enterprise memory arrays.

The memory controller 104 may be configured to control operations of the memory device 103, such as read, erase, and program operations. The memory controller 104 may also be configured to manage various functions regarding data stored or to be stored in the memory device 103, including but not limited to bad block management, garbage collection, logical to physical address conversion, wear leveling, etc. In an implementation, the memory controller 104 is also configured to process error correction codes (ECC) regarding data read from or written to the memory device 103. In an example of the present application, the memory controller 104 is configured to obtain the compute results of the firmware algorithm, and then communicate with at least one of the memory device 103 or the host 101 based on the compute results of the firmware algorithm.

The memory controller 104 may also perform any other suitable functions, such as formatting the memory device 103. The memory controller 104 may communicate with an external device (e.g., the host 101) according to a specific communication protocol. For example, the memory controller 104 may communicate with an external device through at least one of various interface protocols, such as a USB protocol, an MMC (Multi Media Card) protocol, a Peripheral Component Interconnect (PCI) protocol, a PCI-Express (PCI-E) protocol, an Advanced Technology Attachment (ATA) protocol, a Serial ATA protocol (SATA), a Parallel ATA protocol, a Small Computer System Interface (SCSI) protocol, an Enhanced Small Drive Interface (ESDI) protocol, an Integrated Drive Electronics (IDE) protocol, a Firewire protocol, an NVMe (Non-Volatile Memory express) protocol, and the like.

The memory controller 104 and the one or more memory device 103 may be integrated into various types of memory systems 102, for example, included in the same package (e.g., Universal Flash Storage (UFS) package or eMMC package). That is, the memory system 102 may be implemented and packaged into different types of terminal electronic products.

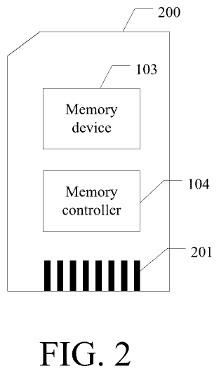

In some examples, as shown in FIG. 2, the memory controller 104 and the single memory device 103 may be integrated into a memory card 200. The memory card 200 may include a PC card (Personal Computer Memory Card International Association, PCMCIA, PC for short), a CF card, a Smart Media (SM) card, a memory stick, a multimedia card (MMC, RS-MMC (Reduced-Size MMC), MMCmicro (micro multimedia card)), an SD card (SD, miniSD (small secure digital memory card), microSD (micro secure digital memory card), SDHC (Secure Digital High Capacity), UFS, etc. The memory card 200 may also include a memory card connector 201 that couples the memory card 200 with a host (e.g., the host 101 in FIG. 1).

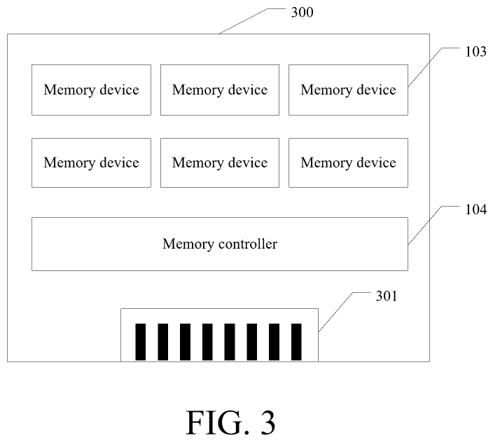

In some examples, as shown in FIG. 3, the memory controller 104 and the plurality of memory device 103 may be integrated into a solid state drive (also referred to as a solid state drive) 300. The solid state drive 300 may further include a solid state drive connector 301 for coupling the solid state drive 300 with a host (e.g., the host 101 in FIG. 1). In an implementation, at least one of the storage capacity or operating speed of the solid state drive 300 is greater than at least one of the storage capacity or operating speed of the memory card 200.

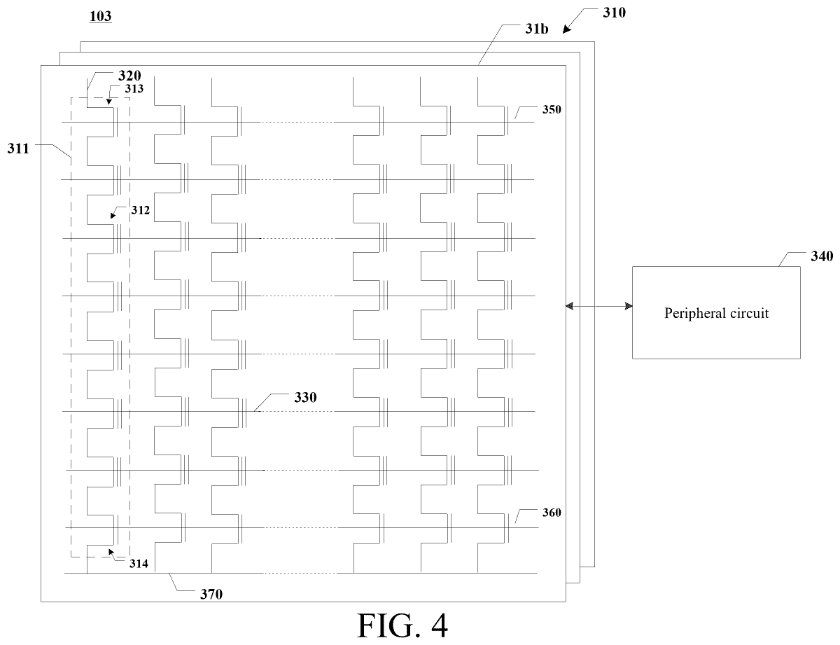

FIG. 4 shows a schematic diagram of a memory device provided by an example of the present application. As shown in FIG. 4, the memory device 103 includes a memory array 310 and a peripheral circuit 340 that is in communication with the memory array 310.

The memory array 310 includes a plurality of memory strings 311 arranged in an array, the plurality of memory strings 311 being located on the supporting side of a substrate (not shown) and extending in a direction perpendicular to the supporting surface of the substrate. In some examples, the supporting surface of the substrate refers to a surface of the substrate for supporting the memory array 310.

Each memory string 311 includes a plurality of memory cells 312, and the plurality of memory cells 312 in each memory string 311 are stacked in a direction perpendicular to the substrate support surface. Each memory cell 312 has the function of storing data, and the stored data is determined by the number of electrons stored in the memory cell 312, and the number of electrons stored in the memory cell 312 can determine the magnitude of the threshold voltage of the memory cell 312, so the threshold voltage of the memory cell 312 can indicate the data stored therein. The memory cell 312 is a floating gate field effect transistor or a charge trap field effect transistor.

In some examples, the memory cell 312 may be a single level cell (SLC), a multi level cell (MLC), a triple level cell (TLC), or a quad level cell (QLC). SLC, MLC, TLC, and QLC can store 1, 2, 3, and 4 bits of data, respectively.

Each memory string 311 also includes an upper selection tube 313 and a lower selection tube 314. The upper selection tubes 313 at the same height or similar height from the substrate bearing surface in different memory strings 311 are coupled to the same drain select line (Drain Select Line, DSL) 350. The lower selection tubes 314 at the same height or similar height from the substrate bearing surface in different memory strings 311 are coupled to the same source select line (Source Select Line, SSL) 360. Among them, the upper selection tube 313 and the lower selection tube 314 are configured to activate the selected memory string when reading, programming or erasing the memory cell. The upper selection tube 313 is also called the top select gate (Top Select Gate, TSG), and the lower selection tube 314 is also called the bottom select gate (Bottom Select Gate, BSG). In some examples, there is also a dummy cell (Dummy Cell, DC) between the upper selection tube 313 and the memory cell 312, and between the lower selection tube 314 and the memory cell 312.

One end of the memory string 311 is coupled to a bit line (BL) 320, and the other end of the memory string 311 is coupled to a source line (SL) 370.

The memory cells 312 at the same or similar heights from the substrate supporting surface in different memory strings 311 are in the same layer, and multiple memory cells 312 in the same layer constitute a memory cell layer, that is, the memory array 310 includes multiple memory cell layers, and multiple word lines 330 are respectively coupled to the multiple memory cell layers.

All memory strings 311 sharing the same group of word lines in the memory array 310 form a memory block 31b. Each memory block 31b includes multiple memory pages, which are the minimum units for reading and programming (also called writing), and the memory block 31b is the minimum unit for erasing.

In some examples, the source terminals of each memory string 311 in the same memory block 31b are coupled to the same source line 370, which is also called a common source line (CSL). In other words, each memory string 311 in the same memory block 31b has an array common source (ACS). The source terminal of the memory string 311 refers to an end of the memory string 311 for coupling with the source line 370.

The peripheral circuit 340 may be coupled to the memory array 310 via the drain select lines 350, the source select lines 360, the bit lines 320, the source lines 370, and the word lines 330. The peripheral circuit 340 may include any suitable analog, digital, and mixed signal circuits for facilitating the operation of the memory array 310 by applying at least one of voltage signals or current signals to the memory cells 312 via the drain select lines 350, the source select lines 360, the bit lines 320, the source lines 370, and the word lines 330, and at least one of sensing voltage signals or current signals from the memory cells 312.

The peripheral circuit 340 may include various types of peripheral circuits formed using Metal-Oxide-Semiconductor (MOS) technology. The peripheral circuit 340 can control the memory cell 312 in the selected memory string by controlling the voltage of the word line 330 coupled to the selected memory string and the voltage of the bit line 320 coupled to the selected memory string to implement operations such as erasing, programming, reading or verification.

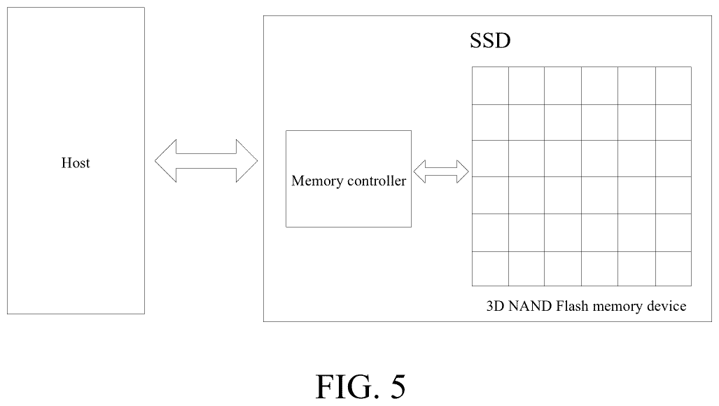

In some examples, the memory system 102 can be implemented as a solid state drive (SSD for short), and the memory device 103 can be implemented as a 3D NAND flash memory device. In this case, the electronic system can be as shown in FIG. 5. In FIG. 5, the SSD includes a memory controller that communicates with the host and a 3D NAND flash memory device, and the memory controller can read and write data in the 3D NAND flash memory device. SSD has the characteristics of low latency, good performance, and low power consumption. It is gradually replacing traditional mechanical hard disks and SATA disks and becoming a more mainstream memory system. It can better adapt to the development of information technology and the surge in user data, which puts higher requirements on data storage.

With the development of storage technology, memory systems are increasingly widely used. Memory systems include memory controllers, which can obtain the results of algorithms by executing them. Algorithms are a series of clear instructions for solving problems, that is, algorithms can obtain the required output within a limited time for certain standard inputs.

In a memory controller (e.g., a memory controller in an SSD), for some fixed algorithms that are particularly time-consuming, hardware (e.g., circuit) is generally configured to solidify the algorithm to unload the CPU's computing power. That is, in one example, a circuit capable of executing the algorithm is prepared in the memory controller, and when the algorithm needs to be executed later, the algorithm's compute result is obtained by running the circuit.

The hardware circuit algorithm solidification requires the preparation of a special circuit, which has poor flexibility and cannot be changed, resulting in reduced versatility. If the algorithm needs to be updated, the circuit needs to be re-prepared, which is costly. In addition, the hardware itself cannot be modified multiple times later like firmware. Once it is taped out, even if there is a problem with the algorithm, it is powerless to correct the problem, especially since the algorithm itself will iterate with optimization, which can easily lead to repeated chip taping and increase costs.

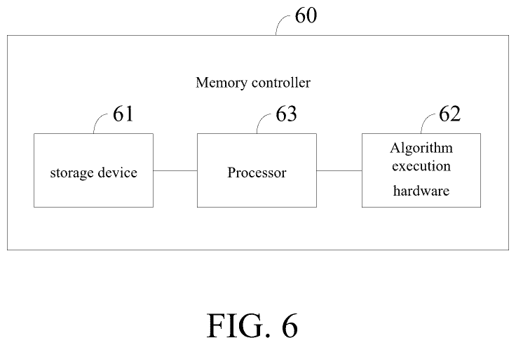

Based on this, an example of the present application provides a memory controller, which can improve the flexibility and versatility of algorithm execution and reduce costs. As shown in FIG. 6, the memory controller 60 provided in the example of the present application includes a storage device 61, algorithm execution hardware 62 and a processor 63, and the processor 63 is connected to the storage device 61 and the algorithm execution hardware 62. In some examples, the memory controller 60 can be the memory controller 104 in FIG. 1 to FIG. 3.

The storage device 61 is configured to store the firmware algorithm. The algorithm execution hardware 62 includes a compute expression, which is obtained according to a configuration of the firmware algorithm. The processor 63 is configured to call the algorithm execution hardware to perform the compute expression when executing the firmware algorithm to obtain a compute result of the firmware algorithm.

The storage device 61 is any hardware with a storage function in the memory controller 60. The example of the present application may not limit the type of the storage device 61. For example, the storage device 61 may be a DRAM. In the example of the present application, a firmware algorithm is stored in the storage device 61. The firmware algorithm refers to an algorithm recorded in firmware (FW) for implementing any function. Firmware refers to software used to drive (or control) hardware in the memory controller 60. That is to say, in the example of the present application, the algorithm is recorded in the software, so as to solve the problem of poor maintenance and poor versatility caused by the hardware solidification algorithm.

The examples of the present application do not limit the type of firmware algorithms. In some examples, the firmware algorithms may include but are not limited to algorithms for controlling memory operations (such as reading, erasing, and programming), algorithms for managing data written to or read from the memory device (such as bad block management algorithms, garbage collection algorithms, logical to physical address conversion algorithms, wear leveling algorithms, error correction code algorithms, etc.), algorithms for communicating with the host, etc.

In some examples, the firmware algorithm may be an algorithm with a large update requirement. An algorithm with a large update requirement may refer to an algorithm that needs to be updated more than a threshold number of times within a reference time period. The reference time period and the threshold number of times may be set based on experience or flexibly adjusted based on application scenarios, and the examples of the present application do not limit this.

In an example, the algorithm with a greater update requirement may be an algorithm associated with the structure of the memory device. The algorithm associated with the structure of the memory device needs to be updated as the structure of the memory device changes, resulting in a greater update requirement. The structure of the memory device refers to the structure of the memory array in the memory device, and the structure of the memory array depends on the number of memory strings in the memory array, the number of memory cells in each memory string, etc. In some examples, the algorithm associated with the structure of the memory device may be an algorithm for parsing the physical address of the memory device to obtain the component parts of the physical address, wherein the physical address of the memory device is an address for locating the storage space in the memory device.

In an example, the algorithms with a greater need for updating may also be some algorithms whose final versions have not been determined. Algorithms whose final versions have not been determined are not easy to solidify in the short term and need to be tuned in combination with firmware later, resulting in a greater need for updating. In some examples, the algorithms whose final versions have not been determined may be algorithms that automatically search for a random seed table (Randomizer Seed Table). The algorithms that automatically search for a random seed table are configured to automatically search for a random seed in the random seed table. The random seed is configured to randomize data to be written to the memory device, or to ensure the randomness of data read from the memory device.

The algorithm execution hardware 62 is hardware in the memory controller 60 for executing the firmware algorithm. The algorithm execution hardware 62 includes a compute expression obtained according to the configuration of the firmware algorithm, so as to execute the firmware algorithm by executing the compute expression later. In other words, the algorithm execution hardware 62 is not a pre-prepared solidified circuit, but a hardware including a configurable compute expression. Based on this, even if the firmware algorithm needs to be updated, it is only necessary to reconfigure the compute expression included in the algorithm execution hardware according to the updated firmware algorithm to implement the execution of the updated firmware algorithm without changing the circuit, thereby reducing costs.

Processor 63 is hardware with processing functions in the memory controller 60. In the example of the present application, processor 63 is configured to determine whether the firmware algorithm needs to be executed, and when it is determined that the firmware algorithm needs to be executed, the algorithm execution hardware 62 is called to perform the compute expression pre-configured according to the firmware algorithm to obtain a compute result of the firmware algorithm.

In some examples, the way in which the processor 63 determines whether it is necessary to execute the firmware algorithm may include: the processor 63 determines whether the execution condition of the firmware algorithm is met, and when the execution condition of the firmware algorithm is met, determines that the firmware algorithm needs to be executed. The execution condition of the firmware algorithm is related to the type of the firmware algorithm, and the examples of the present application are not limited to this. In some examples, the execution condition of the firmware algorithm may include identification information of the firmware algorithm carried in the instruction sent by the host. In some examples, the execution condition of the firmware algorithm may also include that other components in the memory controller 60 output the data required to execute the firmware algorithm or the memory controller 60 obtains the data required to execute the firmware algorithm by communicating with other devices (such as a host, a memory device, etc.).

In an example, the memory controller 60 has a unify compute engine (Unify Compute Engine), which may refer to hardware with computing capabilities in the memory controller 60.

The algorithm execution hardware 62 has a binding relationship with some or all of the configurable compute expressions among a plurality of configurable compute expressions, and the configurable compute expression refers to a compute expression that can be flexibly set according to requirements. In this case, the compute expression included in the algorithm execution hardware 62 may refer to the compute expression obtained after configuring some or all of the configurable compute expressions bound to the algorithm execution hardware 62 according to the firmware algorithm.

In some examples, the memory controller 60 may include a plurality of execution hardware capable of executing a compute expression. A binding relationship is set between the plurality of execution hardware and the plurality of configurable compute expressions. The number of configurable compute expressions bound to different execution hardware may be the same or different, and the example of the present application does not limit this. The example of the present application does not limit the binding relationship between the plurality of execution hardware and the plurality of configurable compute expressions, as long as it is ensured that each execution hardware can implement the task to be executed by itself according to the bound configurable compute expression. The algorithm execution hardware 62 may refer to any execution hardware in which the bound configurable compute expression in the plurality of execution hardware can be configured to execute the firmware algorithm.

In other examples, the unify compute engine includes multiple groups of configurable compute expressions, each group of configurable compute expressions includes a plurality of configurable compute expressions, and the number of configurable compute expressions included in different groups of configurable compute expressions can be the same or different. By grouping the configurable compute expressions, the management standardization of the configurable compute expressions by the unify compute engine can be improved.

The algorithm execution hardware 62 has a binding relationship with some or all of the groups of configurable compute expressions in the plurality of groups of configurable compute expressions, that is, the algorithm execution hardware 62 is bound with the group of configurable compute expressions. In this case, the compute expression included in the algorithm execution hardware 62 may refer to a compute expression obtained by configuring some or all of the configurable compute expressions in the group of configurable compute expressions bound to the algorithm execution hardware 62 according to the firmware algorithm.

In some examples, the memory controller 60 may include a plurality of execution hardware capable of executing a compute expression. A binding relationship is set between the plurality of execution hardware and the plurality of groups of configurable compute expressions. The number of groups of configurable compute expressions bound to different execution hardware may be the same or different, and the example of the present application does not limit this. The example of the present application does not limit the binding relationship between the plurality of execution hardware and the plurality of groups of configurable compute expressions, as long as it is ensured that each execution hardware can implement the task required to be executed by itself according to the bound group of configurable compute expressions. The algorithm execution hardware 62 may refer to any execution hardware in which the configurable compute expression in the bound group of configurable compute expressions in the plurality of execution hardware can be configured to execute the firmware algorithm.

In some examples, the execution hardware may also be referred to as an IP (Intellectual Property) module, the group of configurable compute expressions may also be referred to as a Compute Group, and the configurable compute expression may also be referred to as a Compute Line.

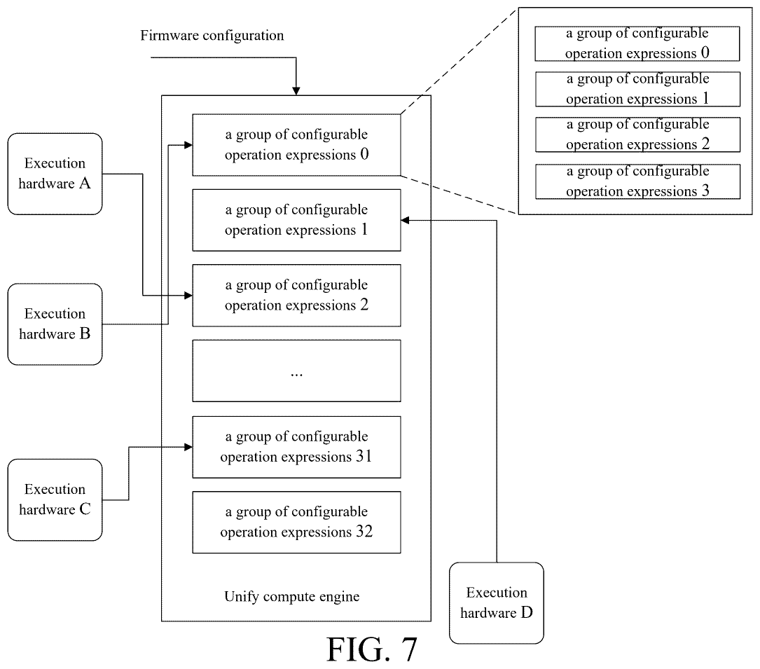

For example, the memory controller 60 includes execution hardware A, execution hardware B, execution hardware C, and execution hardware D; and the unify compute engine includes 33 groups of configurable compute expressions (represented as group 0 of configurable compute expressions, group 1 of configurable compute expressions, group 2 of configurable compute expressions, . . . , group 32 of configurable compute expression). The binding relationships between the execution hardware and the group of configurable compute expressions can be shown in FIG. 7. The execution hardware A has a binding relationship with the group 2 of configurable compute expressions, the execution hardware B has a binding relationship with the group 0 of configurable compute expressions, the execution hardware C has a binding relationship with the group 31 of configurable compute expressions, and the execution hardware D has a binding relationship with the group 1 of configurable compute expressions. It should be noted that the binding relationship shown in FIG. 7 is only an example, and the binding relationship between the execution hardware and the group of configurable compute expressions is not limited to this.

Continuing to refer to FIG. 7, the firmware in the memory controller 60 can configure the configurable compute expressions in the group of configurable compute expressions, and different groups of configurable compute expressions can include completely different, partially identical, or completely identical configurable compute expressions. For example, group 0 of configurable compute expressions includes configurable compute expression 0, configurable compute expression 1, configurable compute expression 2, and configurable compute expression 3.

In some examples, in the case where a binding relationship is set between multiple execution hardware and a plurality of configurable compute expressions, the firmware can determine the configurable compute expression bound to the algorithm execution hardware 62 according to the binding relationship, and then configure a portion or all of the configurable compute expressions bound to the algorithm execution hardware 62 according to the firmware algorithm to obtain the compute expression included in the algorithm execution hardware 62.

In some examples, in the case where a binding relationship is set between multiple execution hardware and multiple groups of configurable compute expressions, the firmware can determine the group of configurable compute expressions bound to the algorithm execution hardware 62 according to the binding relationship, and then configure a portion or all of the configurable compute expressions in the group of configurable compute expressions bound to the algorithm execution hardware 62 according to the firmware algorithm to obtain the compute expressions included in the algorithm execution hardware 62.

The process in which the firmware obtains the compute expression included in the algorithm execution hardware according to a configuration of the firmware algorithm is related to the type of the firmware algorithm. The examples of the present application do not limit this, as long as it is ensured that the compute result of the firmware algorithm can be obtained by executing the compute expression obtained after the configuration.

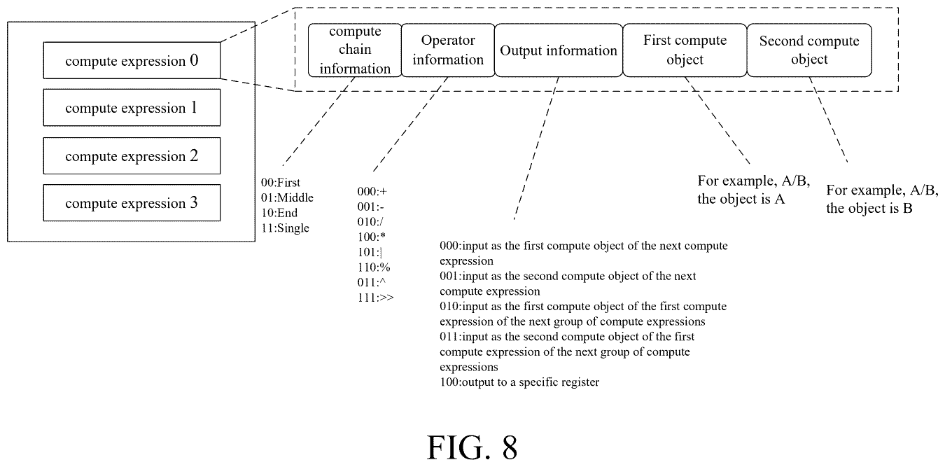

In an implementation, the number of compute expressions included in the algorithm execution hardware 62 includes at least one. Referring to FIG. 8, any compute expression includes a first compute object, a second compute object, operator information, output information, and compute chain information. The first compute object and the second compute object are two objects to be operated; the operator information is to indicate the compute rule between the first compute object and the second compute object; the output information is to indicate a way of outputting a compute result of the first compute object and the second compute object; and the compute chain information is to indicate a position at which any compute expression is located in a plurality of compute expressions. The compute reliability of the compute expression can be guaranteed by a compute expression being represented by the first compute object, the second compute object, the operator information, the output information, and the compute chain information.

The first compute object can also be referred to the compute left value to be computed according to the compute rule, and the second compute object can also be referred to the compute right value to be computed according to the compute rule. For example, referring to FIG. 8, taking the compute rule as a division operation as an example, in the compute expression A/B, A is the first compute object and B is the second compute object.

The operator information is to indicate a compute rule between the first compute object and the second compute object. The compute rule is to indicate how to compute the first compute object and the second compute object in detail. In some examples, the compute rule may include but are not limited to addition operation (+), subtraction operation (−), division operation (/), multiplication operation (*), AND operation (&), OR operation (|), XOR operation (\hat{ }), left shift operation (<<), right shift operation (>>), negation operation (˜), modulo operation (%), etc.

In some examples, different compute rules can be represented with different identifiers, that is, the operator information can be represented with the identifier of the compute rule. The identifier of the compute rule can be set according to experience, or it can be flexibly adjusted according to the application scenario, and the example of the present application does not limit this. For example, as shown in FIG. 8, the compute rule indicated by the operator information may include addition operation (+), subtraction operation (−), division operation (/), multiplication operation (*), or operation (|), modulus operation (%), XOR operation (\hat{ }), right shift operation (>>), 8 compute rules, and the identifiers of the above 8 compute rules include 000, 001, 010, 100, 101, 110, 011, and 111.

The output information is to indicate the way of outputting the compute result of the first compute object and the second compute object, and the way of outputting includes but is not limited to directly outputting the final compute result of the compute expression, as the input of the first compute object or the second compute object of other compute expressions, etc. Other compute expressions may refer to any one or more compute expressions other than the any compute expression in a plurality of compute expressions, and the examples of the present application are not limited to this. In some examples, other compute expressions may include but are not limited to: a compute expression after the any compute expression with one position, a compute expression after the any compute expression with two positions, etc. In some examples, a plurality of compute expressions can be divided into a plurality of groups of compute expressions according to the execution order, and other compute expressions may also include: the first compute expression in the group of compute expressions which is after the group of compute expressions where the any compute expression is with one position, the first compute expression in the group of compute expressions which is after the group of compute expressions where the any compute expression is with two positions, etc.

In some examples, different ways of outputting can be represented with different identifiers, that is, the output information can be represented with the identifier of the way of outputting. The identifier of the way of outputting can be set according to experience, or it can be flexibly adjusted according to the application scenario, and the example of the present application does not limit this. For example, as shown in FIG. 8, the way of outputting indicated by the output information includes five ways of outputting: input as the first compute object of the next compute expression, input as the second compute object of the next compute expression, input as the first compute object of the first compute expression in the next group of compute expressions, input as the second compute object of the first compute expression in the next group of compute expressions, and output to a specific register (me memory). The identifiers of the above five ways of outputting are 000, 001, 010, 011, and 100, respectively. Among them, the specific register refers to an element to store the final compute result of the compute expression, and the specific register can be configured together with the configuration of the compute expression.

The compute chain information is to indicate a position at which any compute expression is located in at least one compute expression, that is, to indicate the order in which any compute expression is executed in at least one compute expression.

In some examples, different positions can be represented with different identifiers, that is, the compute chain information can be represented with the identifier of the position where the compute expression is located. The identifier of the position where the compute expression is located can be set according to experience, or can be flexibly adjusted according to the application scenario, and the examples of the present application do not limit this. For example, the position indicated by the compute chain information includes four positions: the first position (First), the middle position (Middle), the last position (End), and the single position (Single). The identifiers of the above four positions are 00, 01, 10, and 11, respectively. Among them, if the position indicated by the compute chain information is a single position (Single), it means that the number of compute expressions is one.

In some examples, for any compute expression, at least one of the first compute object, the second compute object, the operator information, the output information, and the compute chain information is obtained by the firmware according to a configuration of the firmware algorithm. In the case where information of a portion of the first compute object, the second compute object, the operator information, the output information, and the compute chain information is obtained by the firmware according to a configuration of the firmware algorithm, information of the other portion refers to the information that any compute expression has before being configured according to the firmware algorithm. The information that any compute expression has before being configured according to the firmware algorithm may refer to the information that any compute expression has by default, or may refer to the information configured in the historical configuration process of any compute expression.

The configuration results of the first compute object, the second compute object, the operator information, the output information and the compute chain information in the compute expression are related to the type of the firmware algorithm, and the examples of the present application do not limit this.

In an implementation, the memory controller 60 is coupled to the memory device, and the firmware algorithm is associated with the structure of the memory device; at least one of the first compute object, the second compute object, the operator information, the output information, or the compute chain information is determined based on the structure of the memory device. In other words, the firmware algorithm may be an algorithm associated with the structure of the memory device. In this case, at least one information in the compute expression is determined based on the structure of the memory device. Based on this, if the structure of the memory device changes, the compute expression needs to be reconfigured, to ensure that the configured compute expression is a compute expression associated with the structure of the memory device. In some examples, the structure of the memory device refers to the structure of the memory array in the memory device, and the structure of the memory array depends on the number of memory strings in the memory array, the number of memory cells in each memory string, etc. In some examples, the structure of the memory device can also be referred to as the granules of the memory device.

In some examples, during the process of manufacturing of the memory system, the structure of the memory device may constantly change, and the firmware algorithm associated with the structure of the memory device also needs to constantly change. If the firmware algorithm is solidified as a circuit to execute, the compatibility of the memory controller 60 will be reduced. Based on the method provided in the example of the present application, even if the structure of the memory device changes, only the firmware algorithm is updated, and then the compute expression is reconfigured according to the updated firmware algorithm, without the need to re-prepare the circuit, which has high flexibility and is conducive to cost saving.

In some examples, since the firmware algorithm is recorded in the firmware, the firmware algorithm can be updated by updating the firmware. The example of the present application does not limit the way of updating the firmware, and the firmware can be updated using any firmware update way. For example, the firmware can be updated by uploading a firmware package through the device management service console; the firmware can also be updated through the built-in update function of the operating system of the device, etc.

In an example, when the firmware algorithm is associated with the structure of the memory device, the firmware algorithm may be an algorithm for parsing the physical address of the memory device to obtain component parts of the physical addresses.

The physical address of the memory device is to locate the storage space in the memory device. The physical address of the memory device is obtained by converting the logical address of the memory device by the memory controller 60, that is, the process of parsing the physical address of the memory device is performed after the memory controller 60 converts the logical address of the memory device into the physical address of the memory device. The logical address of the memory device refers to the address used by the user or application to access the data. The logical address is a logical representation of data storage, which allows the user to manage and access the data in a higher level through the operating system and the file system. The logical address does not directly correspond to the specific position of the memory device, but is associated with the physical address through the algorithm and the logical-physical mapping table (Logical-Physical Table, LPT) of the memory controller 60. The physical address refers to the address of a specific position in the memory device, which directly corresponds to the electronic position in the memory device. The physical address refers to the exact position of the memory cell, which is directly accessed by the electronic signal without any conversion or translation. In some examples, the process of parsing the physical address of the memory device by the memory controller 60 can be a process of mapping management by the memory controller 60.

In some examples, the physical addresses of the memory device include multiple component parts. In different memory structures, the number of bits occupied by the same component part in the physical addresses of the memory device may be different, which may result in the inability to accurately locate the storage space in the memory device directly according to the physical address of the memory device. Therefore, it is necessary to parse the various component parts from the physical addresses of the memory device so as to more accurately locate the storage space in the memory device according to the various component parts. In some examples, for the case where the firmware algorithm is to parse the physical addresses of the memory device to obtain the component parts of the physical addresses, the firmware algorithm can also be called an algorithm for calculating the component of the PAA (physical address).

Since the number of bits occupied by the same component part in the physical addresses of the memory device may be different in different memory structures, the physical addresses of the memory device need to be parsed according to different algorithms in different memory structures, that is, the firmware algorithm is associated with the structure of the memory device.

In an example, the number of component parts of the physical addresses of the memory device and the number of compute expressions are both N, the N compute expressions correspond to the N component parts one-to-one, N is an integer not less than 2, the physical addresses of the memory device are represented by a binary value, and the N component parts are arranged in sequence from the low bit to the high bit of the binary value. The value of N can be flexibly set according to demand, for example, the value of N can be 5, or 8, etc. In some examples, the order from the low bit to the high bit of the binary value refers to the order from the rightmost value to the leftmost value of the binary value.

The second compute object of the i^{th} compute expression among the N compute expressions is the number of bits corresponding to the i^{th} component part, and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by the value of the number of bits corresponding to the i^{th} component part to obtain the shifted value; the compute chain information in the i^{th} compute expression is to indicate the i^{th} position; i is an integer not less than 1 and not greater than N.

The number of bits corresponding to the i^{th} component part refers to the number of bits occupied by the i^{th} component part in the physical addresses. In the case of different memory structures, the number of bits corresponding to the i^{th} component part may be the same or different. In some examples, the process of shifting the value of the number of bits corresponding to the i^{th} component part from the low bit of the first compute object in the i^{th} compute expression can also be referred to the process of right shifting the value of the number of bits corresponding to the i^{th} component part.

When the value of i is not taken as N, the output information in the i^{th} compute expression is to indicate that the value shifted by the shift is output as the analytical result of the i^{th} component part and the shifted value obtained by the shift is output as the first compute object in the (i+1)^{th} compute expression; when the value of i is taken as N, the output information in the i^{th} compute expression is to indicate that the value shifted by the shift is output as the analytical result of the i^{th} component part.

When the value of i is taken as 1, the first compute object in the i^{th} compute expression is a binary value; when the value of i is taken as 1, the first compute object in the i^{th} compute expression is the shifted value output by the (i−1)^{th} compute expression.

Next, the N compute expressions involved above are further explained with reference to specific examples.

Taking the memory device as NAND as an example, the physical addresses of the memory device include 5 component parts, namely AU (Allocate Unit), Page (memory page), Block (memory block), CH (Channel) and CE (Chip Enable), and the 5 component parts are arranged from the low bit to the high bit of the physical addresses. In the current structure of the memory device, the number of bits corresponding to the component part AU is 2 bits, the number of bits corresponding to the component part Page is 12 bits, the number of bits corresponding to the component part Block is 10 bits, the number of bits corresponding to the component part CH is 4 bits, and the number of bits corresponding to the component part CE is 3 bits.

The value in AU component part in the physical addresses is to indicate which AU in a memory page. AU is the name of each part after a memory page of NAND is divided into 4 parts. The value of the Page component part in the physical addresses is to indicate which page or pages in a memory block. Page is the name of each memory page in NAND. Memory page is a virtual concept, not a physical concept. For SLC, each memory cell contains 1 bit of information. At this time, when reading the information stored in a layer of memory cells at the physical level, the corresponding information is read for one page; while for MLC, each memory cell contains 2 bits of information. At this time, when reading the information stored in a layer of memory cells at the physical level, the corresponding information is read for 2 pages.

The value of the Block component part in the physical addresses is to indicate which Block in NAND. The value of the CH component part in the physical addresses is to indicate which group of physical pins in NAND is responsible for receiving and transmitting data and commands. The value of the CE component part in the physical addresses is to indicate which CE pins in NAND.

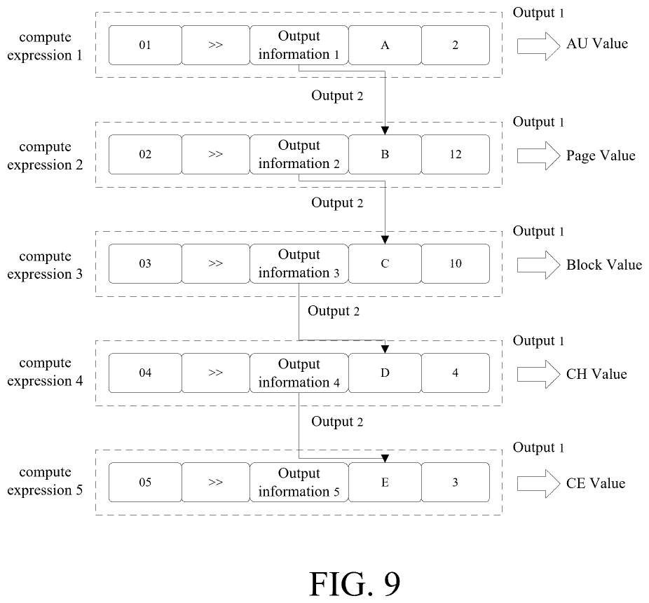

Referring to FIG. 9, the algorithm execution hardware 62 includes five compute expressions, namely, compute expression 1 corresponding to component part AU, compute expression 2 corresponding to component part Page, compute expression 3 corresponding to component part Block, compute expression 4 corresponding to component part CH, and compute expression 5 corresponding to component part CE.

For compute expression 1, the first compute object is a binary value (A) representing a physical address; the second compute object is 2; the compute rule indicated by the operator information is to shift the lower bit of the binary value (A) by 2 values to obtain the shifted value (B); the compute chain information is to indicate being in the first bit (indicated by the identifier 01); the output information (represented as output information 1 in FIG. 9) is to indicate that the value shifted by the shift is output as the analytical result (AU value) of the component part AU and that the shifted value (B) is output as the first compute object in compute expression 2.

For compute expression 2, the first compute object is the shifted value (B) output by compute expression 1; the second compute object is 12; the compute rule indicated by the operator information is to shift the lower bit of the shifted value (B) by 12 values to obtain the shifted value (C); the compute chain information is to indicate being in the second bit (indicated by the identifier 02); the output information (represented as output information 2 in FIG. 9) is to indicate that the value shifted by the shift is output as the parsing result (Page value) of the component part Page and that the shifted value (C) is output as the first compute object in compute expression 3.

For compute expression 3, the first compute object is the shifted value (C) output by compute expression 2; the second compute object is 10; the compute rule indicated by the operator information is to shift the lower bit of the shifted value (C) by 10 values to obtain the shifted value (D); the compute chain information is to indicate being in the third bit (indicated by the identifier 03); the output information (represented as output information 3 in FIG. 9) is to indicate that the value shifted by the shift is output as the parsing result (Block value) of the component part Block and that the shifted value (D) is output as the first compute object in compute expression 4.

For compute expression 4, the first compute object is the shifted value (D) output by compute expression 3; the second compute object is 4; the compute rule indicated by the operator information is to shift the lower bit of the shifted value (D) by 4 values to obtain the shifted value (E); the compute chain information is to indicate being in the fourth bit (indicated by the identifier 04); the output information (represented as output information 4 in FIG. 9) is to indicate that the value shifted by the shift is output as the analytical result (CH value) of the component part CH and that the shifted value (E) is output as the first compute object in compute expression 5.

For compute expression 5, the first compute object is the shifted value (E) output by compute expression 4; the second compute object is 3; the compute rule indicated by the operator information is to shift the lower bit of the shifted value (E) by 3 values to obtain the shifted value (empty value); the compute chain information is to indicate being in the 5th bit (indicated by the identifier 05); the output information (represented as output information 5 in FIG. 9) is to indicate that the value shifted by the shift is output as the analytical result (CE value) of component part CE.

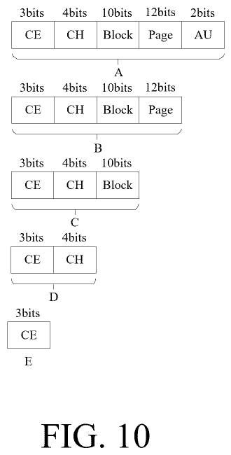

The first compute object (i.e., the values A, B, C, D, and E) in the above five compute expressions can be seen in FIG. 10. The value A is a value including the component parts AU, Page, Block, CH, and CE. The number of bits occupied by the component part AU is 2 bits, the number of bits occupied by the component part Page is 12 bits, the number of bits occupied by the component part Block is 10 bits, the number of bits occupied by the component part CH is 4 bits, and the number of bits occupied by the component part CE is 3 bits.

Value B is the value obtained by shifting the low bit of value A by 2 values and including the component parts Page, Block, CH and CE, value C is the value obtained by shifting the low bit of value B by 12 values and including the component parts Block, CH and CE, value D is the value obtained by shifting the low bit of value C by 10 values and including the component parts CH and CE, value E is the value obtained by shifting the low bit of value D by 4 values and including the component part CE. According to the compute expression shown in FIG. 9, the larger value A can be split level by level to obtain the values of the component elements therein. Since the number of bits occupied by each component element of value A will change with the structure of the memory device, the process of parsing the component elements of value A can be implemented by configuring the compute expression provided in the example of the present application.

In some examples, in addition to being an algorithm associated with the structure of the memory device, the firmware algorithm may also be other algorithms with greater update requirements. In some examples, the firmware algorithm may also be some algorithms whose final versions have not been determined, such as an algorithm for automatically searching for a Randomizer Seed Table, which is not easy to solidify in the short term and needs to be combined with later firmware tuning. The memory controller 60 provided in the example of the present application executes the algorithm, which is conducive to improve the flexibility of algorithm execution, improve versatility, and reduce the cost of updating the algorithm.

The memory controller 60 provided in the example of the present application supports software (firmware) to define the compute expression of hardware (algorithm execution hardware). The firmware can dynamically configure the compute expression of the hardware according to the algorithm, and the hardware executes the compute expression configured by the firmware in sequence to obtain the compute result of the algorithm. This memory controller 60 can improve the feasibility of the algorithm tuning of the memory controller 60 in the later stage. Compared with the solution of hardware algorithm solidification, the software definition method has better flexibility and is conducive to reduce the cost consumption caused by repeated chip tape-out.

In an example of the present application, the algorithm execution hardware includes a compute expression configured according to the firmware algorithm, so that the processor can obtain a compute result of the firmware algorithm by calling the algorithm execution hardware to perform the compute expression. This kind of memory controller can implement the execution of the firmware algorithm through the combination of the compute expression and the algorithm execution hardware. It is not necessary to prepare a special circuit to implement the execution of the firmware algorithm, and it has high flexibility and high versatility. In addition, if the firmware algorithm needs to be updated, it is only necessary to reconfigure the compute expression included in the algorithm execution hardware according to the updated firmware algorithm to implement the execution of the updated firmware algorithm, without changing the circuit, and the cost is low.

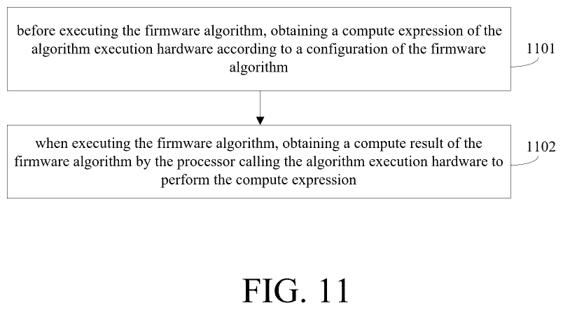

The example of the present application provides a method of operating a memory controller, the memory controller includes a storage device, algorithm execution hardware and a processor, and the storage device stores a firmware algorithm. The memory controller may be the memory controller 60 in FIG. 6. Referring to FIG. 11, the method of operating the memory controller includes operations 1101 and 1102:

In operation 1101, before executing the firmware algorithm, obtaining a compute expression of the algorithm execution hardware according to a configuration of the firmware algorithm.

In operation 1102, when executing the firmware algorithm, obtaining a compute result of the firmware algorithm by the processor calling the algorithm execution hardware to perform the compute expression.

In an implementation, the algorithm execution hardware is bound to a group of configurable compute expressions, and the compute expression is obtained by configuring a portion or all of the configurable compute expressions in the group of configurable compute expressions according to a firmware algorithm.

In an implementation, the number of compute expressions is at least one, and any compute expression includes a first compute object, a second compute object, operator information, output information, and compute chain information; wherein the first compute object and the second compute object are two objects to be operated; the operator information is to indicate the compute rule between the first compute object and the second compute object; the output information is to indicate a way of outputting a compute result of the first compute object and the second compute object; and the compute chain information is to indicate a position at which any compute expression is in at least one compute expression.

In an implementation, a memory controller is coupled to a memory device, a firmware algorithm is associated with a structure of the memory device, and at least one of a first compute object, a second compute object, operator information, output information, or compute chain information is determined based on the structure of the memory device.

In an implementation, a firmware algorithm is to parse physical addresses of a memory device to obtain component parts of the physical addresses, and the physical address of the memory device is to locate storage space in the memory device.

In an implementation, the number of component parts of the physical addresses of the memory device and the number of compute expressions are both N, the N compute expressions correspond to the N component parts one-to-one, N is an integer not less than 2, the physical addresses of the memory device are represented by a binary value, and the N component parts are arranged in sequence from the low bit to the high bit of the binary value; the second compute object in the i^{th} compute expression in the N compute expressions is the number of bits corresponding to the i^{th} component part, and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by the value of the number of bits corresponding to the i^{th} component part to obtain the shifted value; the compute chain information in the i^{th} compute expression is to indicate the i^{th} bit; i is an integer not less than 1 and not greater than N.

Wherein, when the value of i is not taken as N, the output information in the i^{th} compute expression is to indicate that the value shifted by shifting is output as the analytical result of the i^{th} component part and the shifted value obtained by shifting is output as the first compute object in the (i+1)^{th} compute expression; when the value of i is taken as N, the output information in the i^{th} compute expression is to indicate that the value shifted by shifting is output as the analytical result of the i^{th} component part; when the value of i is taken as 1, the first compute object in the i^{th} compute expression is a binary value; when the value of i is not taken as 1, the first compute object in the i^{th} compute expression is the shifted value output by the (i−1)^{th} compute expression.

The description of the above example of a method of operating a memory controller has similar beneficial effects as the above example of memory controller hardware (example shown in FIG. 6). For technical details not disclosed in the example of the method of operating the memory controller, please refer to the description of example of the memory controller hardware of the present application for understanding.

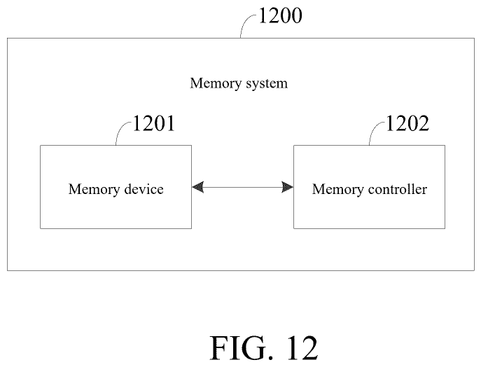

The example of the present application provides a memory system, as shown in FIG. 12, the memory system 1200 includes a memory device 1201 and a memory controller 1202 coupled to the memory device 1201. The memory controller 1202 may be the memory controller 60 in FIG. 6, and the memory device 1201 may be the memory device 103 in FIG. 1 to FIG. 4.

In an implementation, the memory controller 1202 is configured to, when the compute result is associated with the operation of the memory device 1201, obtain operation information of the memory device 1201 based on the compute result, and send the operation information to the memory device 1201. The memory device 1201 is configured to receive the operation information and perform an operation corresponding to the operation information.

When the compute result of the firmware algorithm is associated with the operation of the memory device 1201, after obtaining the compute result of the firmware algorithm, the memory controller 1202 obtains the operation information of the memory device 1201 based on the compute result, and communicates with the memory device 1201 based on the operation information of the memory device 1201 to inform the memory device 1201 of the operation to be performed.

The association between the compute result of the firmware algorithm and the operation of the memory device 1201 can be understood as the compute result of the firmware algorithm required to be used in the operation (such as reading, programming, erasing, etc.) of the memory device 1201. The operation information of the memory device 1201 is to indicate the operation that the memory device 1201 needs to perform based on the compute result. The way of obtaining the operation information of the memory device 1201 based on the compute result is related to the type of the firmware algorithm and the type of the compute result of the firmware algorithm, etc., and the example of the present application does not limit this, as long as the memory device 1201 can know what operation needs to be performed according to the operation information.

In some examples, the association between the compute result of the firmware algorithm and the operation of the memory device 1201 may mean that the compute result of the firmware algorithm is data that needs to be written into the memory device 1201. In this case, the way of obtaining the operation information of the memory device 1201 based on the compute result may be: using information including the compute result and the address of the first storage space in the memory device 1201 as the operation information of the memory device 1201. After receiving such operation information, the memory device 1201 determines the first storage space according to the address of the first storage space, and writes the compute result into the first storage space.

In some examples, the association between the compute result of the firmware algorithm and the operation of the memory device 1201 may also mean that the compute result of the firmware algorithm includes the address of the second storage space of the data to be read in the memory device 1201. In this case, the way of obtaining the operation information of the memory device 1201 based on the compute result may be: using the address of the second storage space as the operation information of the memory device 1201. After receiving such operation information, the memory device 1201 determines the second storage space according to the address of the second storage space, reads the data in the second storage space, and feeds back the read data to the memory controller 1202.

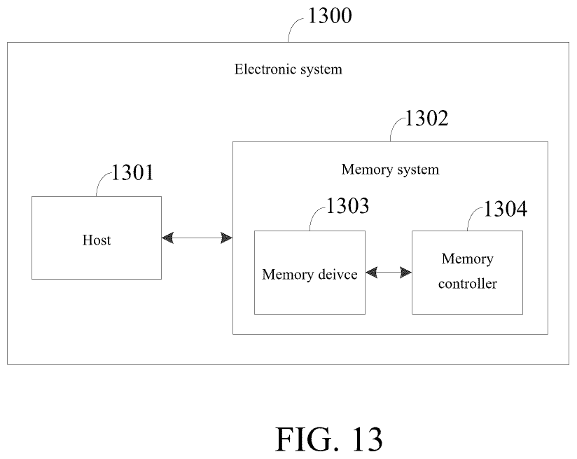

An example of the present application provides an electronic system, as shown in FIG. 13, the electronic system 1300 includes a host 1301 and a memory system 1302 coupled to the host 1301, the memory system 1302 includes a memory device 1303 and a memory controller 1304 coupled to the memory device 1303. In some examples, the electronic system 1300 may be the electronic system 100 in FIG. 1, the host 1301 may be the host 101 in FIG. 1, the memory system 1302 may be the memory system 102 in FIG. 1, the memory device 1303 may be the memory device 103 in FIG. 1 to FIG. 4, and the memory controller 1304 may be the memory controller 60 in FIG. 6.

In an implementation, the memory controller 1304 is configured to, when the compute result is associated with the operation of the memory device 1303, obtain the operation information of the memory device 1303 based on the compute result, and send the operation information to the memory device 1303. The memory device 1303 is configured to receive the operation information and perform an operation corresponding to the operation information.

When the compute result of the firmware algorithm is associated with the operation of the memory device 1303, after obtaining the compute result of the firmware algorithm, the memory controller 1304 obtains the operation information of the memory device 1303 based on the compute result, and communicates with the memory device 1303 based on the operation information of the memory device 1303 to inform the memory device 1303 of the operation to be performed.

The association between the compute result of the firmware algorithm and the operation of the memory device 1303 can be understood as the compute result of the firmware algorithm needs to be used in the operation (such as reading, programming, erasing, etc.) of the memory device 1303. The operation information of the memory device 1303 is configured to indicate the operation that the memory device 1303 needs to perform based on the compute result. The method of obtaining the operation information of the memory device 1303 based on the compute result is related to the type of the firmware algorithm and the type of the compute result of the firmware algorithm, etc., and the example of the present application does not limit this, as long as the memory device 1303 can know what operation needs to be performed according to the operation information.

In some examples, the compute result of the firmware algorithm and the operation association of the memory device 1303 may mean that the compute result of the firmware algorithm is data that needs to be written into the memory device 1303. In this case, the method of obtaining the operation information of the memory device 1303 based on the compute result may be: using information including the compute result and the address of the first storage space in the memory device 1303 as the operation information of the memory device 1303. After receiving such operation information, the memory device 1303 determines the first storage space according to the address of the first storage space, and writes the compute result into the first storage space.

In some examples, the compute result of the firmware algorithm and the operation association of the memory device 1303 may also mean that the compute result of the firmware algorithm includes the address of the second storage space of the data to be read in the memory device 1303. In this case, the method of obtaining the operation information of the memory device 1303 based on the compute result may be: using the address of the second storage space as the operation information of the memory device 1303. After receiving such operation information, the memory device 1303 determines the second storage space according to the address of the second storage space, reads the data in the second storage space, and feeds back the read data to the memory controller 1304.

In an implementation, the memory controller 1304 is configured to send the compute result to the host 1301 when the compute result is associated with the host. The host 1301 is configured to receive the compute result.

In the case where the compute result of the firmware algorithm is associated with the host 1301, after obtaining the compute result of the firmware algorithm, the memory controller 1304 sends the compute result to the host 1301, so that the host 1301 receives the compute result.

In some examples, the compute result of the firmware algorithm being associated with the host 1301 may mean that the compute result of the firmware algorithm is the result obtained after the firmware algorithm is executed according to the instruction sent by the host 1301. In some examples, the compute result of the firmware algorithm being associated with the host 1301 may also mean that the operation of the host 1301 requires the use of the compute result of the firmware algorithm.

It should be understood that the “plurality” mentioned in this article refers to two or more. “And/or” describes the association relationship of the associated objects, indicating that there can be three relationships. For example, A and/or B can mean: A exists alone, A and B exist at the same time, and B exists alone. The character “/” generally indicates that the associated objects are in an “or” relationship.

The examples of the present application provide a memory controller and operation method thereof, a memory system and an electronic system. The technical solution is as follows:

In one aspect, an example of the present application provides a memory controller, comprising:
a storage device configured to store a firmware algorithm;
an algorithm execution hardware, the algorithm execution hardware including a compute expression, the compute expression is obtained according to a configuration of the firmware algorithm; and
a processor connected to the storage device and the algorithm execution hardware, configured to call the algorithm execution hardware to perform the compute expression when executing the firmware algorithm, to obtain a compute result of the firmware algorithm.

In an implementation, the algorithm execution hardware is bound to a group of configurable compute expressions, and the compute expression is obtained by configuring a portion or all of the configurable compute expressions in the group of configurable compute expressions according to the firmware algorithm.

In an implementation, the number of the compute expressions is at least one, and any compute expression includes a first compute object, a second compute object, operator information, output information and compute chain information; wherein the first compute object and the second compute object are two objects to be operated; the operator information is to indicate a compute rule between the first compute object and the second compute object; the output information is to indicate a way of outputting a compute result of the first compute object and the second compute object; and the compute chain information is to indicate a position at which any compute expression is located in at least one compute expression.

In an implementation, the memory controller is coupled to a memory device, the firmware algorithm is associated with a structure of the memory device, and at least one of the first compute object, the second compute object, the operator information, the output information, or the compute chain information is determined based on the structure of the memory device.

In an implementation, the firmware algorithm is to parse physical addresses of the memory device to obtain component parts of the physical addresses, and the physical address of the memory device is to locate storage space in the memory device.

In an implementation, the number of component parts of the physical addresses of the memory device and the number of the compute expressions are both N, the N compute expressions correspond to the N component parts one-to-one, N is an integer not less than 2, the physical addresses of the memory device are represented by a binary value, and the N component parts are arranged in sequence from a low bit to a high bit of the binary value;

The second compute object in the i^{th} compute expression among the N compute expressions is the number of bits corresponding to the i^{th} component part, and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by the value of the number of bits corresponding to the i^{th} component part to obtain the shifted value; the compute chain information in the i^{th} compute expression is to indicate the i^{th} position; i is an integer not less than 1 and not greater than N;

Wherein, when the value of i is not taken as N, the output information in the i^{th} compute expression is to indicate that the value shifted by the shift is output as the analytical result of the i^{th} component part and the shifted value obtained by the shift is output as the first compute object in the (i+1)^{th} compute expression; when the value of i is taken as N, the output information in the i^{th} compute expression is to indicate that the value shifted by the shift is output as the analytical result of the i^{th} component part;

When the value of i is taken as 1, the first compute object in the i^{th} compute expression is the binary value; when the value of i is taken as 1, the first compute object in the i^{th} compute expression is the shifted value output by the (i−1)^{th} compute expression.

On the other hand, an example of the present application provides a method of operating a memory controller, wherein the memory controller includes a storage device, algorithm execution hardware, and a processor, wherein the storage device stores a firmware algorithm; the method includes:

Before executing the firmware algorithm, obtaining a compute expression of the algorithm execution hardware according to a configuration of the firmware algorithm;

When executing the firmware algorithm, the processor calls the algorithm execution hardware to perform the compute expression to obtain a compute result of the firmware algorithm.

In an implementation, the algorithm execution hardware is bound to a group of configurable compute expressions, and the compute expression is obtained by configuring a portion or all of the configurable compute expressions in the group of configurable compute expressions according to the firmware algorithm.

In an implementation, the number of compute expressions includes multiple, and any compute expression includes a first compute object, a second compute object, operator information, output information and compute chain information; wherein the first compute object and the second compute object are two objects to be operated; the operator information is to indicate a compute rule between the first compute object and the second compute object; the output information is to indicate a way of outputting a compute result of the first compute object and the second compute object; and the compute chain information is to indicate a position at which any compute expression is located in a plurality of compute expressions.

In an implementation, the memory controller is coupled to a memory device, the firmware algorithm is associated with a structure of the memory device, and at least one of the first compute object, the second compute object, the operator information, the output information, or the compute chain information is determined based on the structure of the memory device.

In an implementation, the firmware algorithm is to parse physical addresses of the memory device to obtain component parts of the physical addresses, and the physical address of the memory device is to locate storage space in the memory device.

In an implementation, the number of component parts of the physical addresses of the memory device and the number of the compute expressions are both N, the N compute expressions correspond to the N component parts one-to-one, N is an integer not less than 2, the physical addresses of the memory device are represented by a binary value, and the N component parts are arranged in sequence from a low bit to a high bit of the binary value;

The second compute object in the i^{th} compute expression in the N compute expression is the number of bits corresponding to the i^{th} component part, and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by the value of the number of bits corresponding to the i^{th} component part to obtain the shifted value; the compute chain information in the i^{th} compute expression is to indicate the i^{th} position; i is an integer not less than 1 and not greater than N;

Wherein, when the value of i is not taken as N, the output information in the i^{th} compute expression is to indicate that the value shifted by the shift is output as the analytical result of the i^{th} component part and the shifted value obtained by the shift is output as the first compute object in the (i+1)^{th} compute expression; when the value of i is taken as N, the output information in the i^{th} compute expression is to indicate that the value shifted by the shift is output as the analytical result of the i^{th} component part;

When the value of i is taken as 1, the first compute object in the i^{th} compute expression is the binary value; when the value of i is taken as 1, the first compute object in the i^{th} compute expression is the shifted value output by the (i−1)^{th} compute expression.

On the other hand, an example of the present application provides a memory system, which includes a memory device and a memory controller coupled to the memory device, and the memory controller is any of the memory controllers described above.

In an implementation, the memory controller is configured to, when the compute result is associated with the operation of the memory device, obtain the operation information of the memory device based on the compute result, and send the operation information to the memory device;

The memory device is configured to receive the operation information and perform an operation corresponding to the operation information.

On the other hand, an example of the present application provides an electronic system, which includes a host and a memory system coupled to the host, the memory system includes a memory device and a memory controller coupled to the memory device, and the memory controller is any of the memory controllers described above.

In an implementation, the memory controller is configured to, when the compute result is associated with the operation of the memory device, obtain the operation information of the memory device based on the compute result, and send the operation information to the memory device;

The memory device is configured to receive the operation information and perform an operation corresponding to the operation information.

In an implementation, when the compute result is associated with the host, the memory controller is configured to send the compute result to the host;

The host is configured to receive the compute result.

The above description is only an example of the present application and is not intended to limit the present application. Any modifications, equivalent substitutions, improvements, etc. made within the principles of the present application shall be included in the protection scope of the present application.

What is claimed is:

1. A memory controller, comprising:
a storage device configured to store a firmware algorithm;
an algorithm execution hardware including a compute expression which is obtained according to a configuration of the firmware algorithm; and
a processor connected to the storage device and the algorithm execution hardware, and configured to, when executing the firmware algorithm, call the algorithm execution hardware to perform the compute expression, to obtain a compute result of the firmware algorithm.

2. The memory controller of claim 1, wherein the algorithm execution hardware is bound to a group of configurable compute expressions, the compute expression is obtained by configuring a portion or all of the configurable compute expressions in the group of configurable compute expressions according to the firmware algorithm.

3. The memory controller of claim 1, wherein a number of the compute expression is at least one, and any compute expression comprises a first compute object, a second compute object, operator information, output information, and compute chain information; and
wherein, the first compute object and the second compute object are two objects to be operated; the operator information is to indicate a compute rule between the first compute object and the second compute object; the output information is to indicate a way of outputting a compute result of the first compute object and the second compute object; and the compute chain information is to indicate a position at which any compute expression is in at least one compute expression.

4. The memory controller of claim 3, wherein the memory controller is coupled to a memory device, the firmware algorithm is associated with a structure of the memory device; and at least one of the first compute object, the second compute object, the operator information, the output information or the compute chain information is determined based on the structure of the memory device.

5. The memory controller of claim 4, wherein the firmware algorithm is to parse physical addresses of the memory device to obtain component parts of the physical addresses, and the physical addresses of the memory device is to locate storage space in the memory device.

6. The memory controller of claim 5, wherein a number of the component parts of the physical addresses and the number of the compute expression are both N, N compute expressions correspond to N component parts one-to-one, N is an integer not less than 2, the physical addresses of the memory device are represented by a binary value, and the N component parts are arranged in sequence from low bit to high bit of the binary value;
the second compute object in the i^{th} compute expression in the N compute expressions is a number of bits corresponding to the i^{th} component part and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by a value of the number of bits corresponding to the i^{th} component part to obtain a shifted value; the compute chain information in the i^{th} compute expression is to indicate the i^{th} position; i is an integer not less than 1 and not greater than N;
wherein, when a value of i is not taken as N, the output information in the i^{th} compute expression is to indicate that a value shifted by the shift is output as an analytical result of the i^{th} component part and the shifted value obtained by the shift is output as the first compute object in the (i+1)^{th} compute expression; when the value of i is taken as N, the output information in the i^{th} compute expression is to indicate that the value shifted by the shift is output as the analytical result of the i^{th} component part; and
when the value of i is taken as 1, the first compute object in the i^{th} compute expression is the binary value; when the value of i is taken as 1, the first compute object in the i^{th} compute expression is the shifted value output by the (i−1)^{th} compute expression.

7. A memory system, comprising:
a memory device; and
a memory controller coupled to the memory device, and comprising:
a memory device configured to store a firmware algorithm;
an algorithm execution hardware including a compute expression which is obtained according to a configuration of the firmware algorithm; and
a processor connected to the memory device and the algorithm execution hardware, and configured to, when executing the firmware algorithm, call the algorithm execution hardware to perform the compute expression, to obtain a compute result of the firmware algorithm.

8. The memory system of claim 7, wherein the memory controller is configured to, when the compute result is associated with an operation of the memory device, obtain operation information of the memory device based on the compute result, and send the operation information to the memory device; and
the memory device is configured to receive the operation information, perform an operation corresponding to the operation information.

9. The memory system of claim 7, wherein the algorithm execution hardware is bound to a group of configurable compute expressions, the compute expression is obtained by configuring a portion or all of the configurable compute expressions in the group of configurable compute expressions according to the firmware algorithm.

10. The memory system of claim 7, wherein a number of the compute expression is at least one, and any compute expression comprises a first compute object, a second compute object, operator information, output information, and compute chain information; and
wherein, the first compute object and the second compute object are two objects to be operated; the operator information is to indicate a compute rule between the first compute object and the second compute object; the output information is to indicate a way of outputting a compute result of the first compute object and the second compute object; and the compute chain information is to indicate a position at which any compute expression is in at least one compute expression.

11. The memory system of claim 10, wherein the memory controller is coupled to a memory device, the firmware algorithm is associated with a structure of the memory device; and at least one of the first compute object, the second compute object, the operator information, the output information or the compute chain information is determined based on the structure of the memory device.

12. The memory system of claim 11, wherein the firmware algorithm is to parse physical addresses of the memory device to obtain component parts of the physical addresses, and the physical addresses of the memory device is to locate storage space in the memory device.

13. The memory system of claim 12, wherein a number of the component parts of the physical addresses and the number of the compute expression are both N, N compute expressions correspond to N component parts one-to-one, N is an integer not less than 2, the physical addresses of the memory device are represented by a binary value, and the N component parts are arranged in sequence from low bit to high bit of the binary value;
the second compute object in the i^{th} compute expression in the N compute expressions is a number of bits corresponding to the i^{th} component part and the number of bits corresponding to the i^{th} component part is determined according to the structure of the memory device; the compute rule indicated by the operator information in the i^{th} compute expression is shift, and the shift is to shift the low bit of the first compute object in the i^{th} compute expression by a value of the number of bits corresponding to the i^{th} component part to obtain a shifted value; the compute chain information in the i^{th} compute expression is to indicate the i^{th} position; i is an integer not less than 1 and not greater than N;
wherein, when a value of i is not taken as N, the output information in the i^{th} compute expression is to indicate that a value shifted by the shift is output as an analytical result of the i^{th} component part and the shifted value obtained by the shift is output as the first compute object in the (i+1)^{th} compute expression; when the value of i is taken as N, the output information in the i^{th} compute expression is to indicate that the value shifted by the shift is output as the analytical result of the i^{th} component part; and
when the value of i is taken as 1, the first compute object in the i^{th} compute expression is the binary value; when the value of i is taken as 1, the first compute object in the i^{th} compute expression is the shifted value output by the (i−1)^{th} compute expression.

14. The memory system of claim 7, wherein the memory system comprises Solid State Disk (SSD).

15. The memory system of claim 7, wherein the memory device comprises 3D NAND flash memory device.

16. A method of operating a memory controller comprising a storage device storing a firmware algorithm, an algorithm execution hardware and a processor, comprising:
before executing the firmware algorithm, obtaining a compute expression of the algorithm execution hardware according to a configuration of the firmware algorithm; and
when executing the firmware algorithm, performing the compute expression by the processor calling the algorithm execution hardware, to obtain a compute result of the firmware algorithm.

17. The method of claim 16, wherein the algorithm execution hardware is bound to a group of configurable compute expressions, the compute expression is obtained by configuring a portion or all of the configurable compute expressions in the group of configurable compute expressions according to the firmware algorithm.

18. The method of claim 16, wherein a number of the compute expression is at least one, and any compute expression comprises a first compute object, a second compute object, operator information, output information, and compute chain information; and
wherein, the first compute object and the second compute object are two objects to be operated; the operator information is to indicate a compute rule between the first compute object and the second compute object; the output information is to indicate a way of outputting a compute result of the first compute object and the second compute object; and the compute chain information is to indicate a position at which any compute expression is in at least one compute expression.

19. The method of claim 18, wherein the memory controller is coupled to a memory device, the firmware algorithm is associated with a structure of the memory device; and at least one of the first compute object, the second compute object, the operator information, the output information or the compute chain information is determined based on the structure of the memory device.

20. The method of claim 19, wherein the firmware algorithm is to parse physical addresses of the memory device to obtain component parts of the physical addresses, and the physical addresses of the memory device is to locate storage space in the memory device.
